(19) United States
(12) Patent Application Publication
(10) Pub. No.: US 2021/0029125 A1
(43) Pub. Date: Jan. 28, 2021

(54) SYSTEMS AND METHODS OF DELEGATION OR REPLICATION ON A PRIVATE NETWORK

(71) Applicant: Whitestar Communications, Inc., Apex, NC (US)

(72) Inventor: Billy Gayle Moon, Apex, NC (US)

(73) Assignee: Whitestar Communications, Inc., Apex, NC (US)

(21) Appl. No.: 16/518,706

(22) Filed: Jul. 22, 2019

(51) Int. Cl. H04L 29/06

(52) U.S. Cl. CPC H04L 63/101; H04L 63/102; H04L 63/104; H04L 63/08

(57) ABSTRACT

The systems and methods of delegation or replication on a private network, comprising: establishing a secure and encrypted private network with one or more profile computing devices; establishing a trust relationship on a whitelist for a first profile computing device; identifying categories of services provided to the first profile including one or more of the following: receiving and executing commands from the first profile; vetting a subscriber before inclusion in a service; receiving from a subscriber; distributing content to one or more subscribers in a group; revoking a subscriber from a group; or reporting task status; receiving a selection of one or more of the services from the first profile; executing one or more of the selected services on behalf of the first profile.

### CROSS-REFERENCE TO RELATED APPLICATIONS

The following Whitestar Communications, Inc.'s concurrently filed patent applications are incorporated herein by reference: (1) Attorney Docket No. WSTAR.001, titled “SYSTEMS AND METHODS OF SALUTATION PROTOCOL TO COMMUNICATE USING A PRIVATE OVERLAY PEER TO PEER NETWORK.” and patent application Ser. No. 16/518,292; (2) Attorney Docket No. WSTAR.002, titled “SYSTEMS AND METHODS OF SECURING DIGITAL CONVERSATIONS FOR ITS LIFE CYCLE AT SOURCE, DURING TRANSIT AND AT DESTINATION” and patent application Ser. No. 16/518,406; (3) Attorney Docket No. WSTAR.003, titled “SYSTEMS AND METHODS OF COLLABORATIVE APPLICATION ON A PRIVATE NETWORK” and patent application Ser. No. 16/518,491; (4) Attorney Docket No. WSTAR.004, titled “SYSTEMS AND METHODS OF ENFORCING COMMUNICATIONS SEMANTICS ON A PRIVATE NETWORK” and patent application Ser. No. 16/518,538; (5) Attorney Docket No. WSTAR.005, titled “SYSTEMS AND METHODS OF GESTURE TRIGGERED AUTOMATIC ERASURE ON A PRIVATE NETWORK” and patent application Ser. No. 16/518,586; and (6) Attorney Docket No. WSTAR.006, titled “SYSTEMS AND METHODS OF DISTRIBUTED BACKUP AND RECOVERY ON A PRIVATE NETWORK” and patent application Ser. No. 16/518,680.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### FIELD OF THE INVENTION

The present invention is in the technical field of delegation or replication services within secure and encrypted private networks. More particularly, the present invention is in the technical field of establishing trusted service providers who operate with trusted subscribers to a service. More particularly, the present invention is in the technical field of vetting your subscribers to ensure that even the list of followers is controlled.

### BACKGROUND

Current social media systems are enabled by central services provided by third parties. In essence, social media is interaction between two or more end-users that mirrors real-life situation where a third-party has no business interfering. But the digital world of the internet applications of social media do not align to the real-world frameworks.

Social media typically facilitates user-generated content including text, comments, photos, videos and voice. Traditionally these various media are generated through “online” interactions and are facilitated by one or more third party platforms such as Twitter, Facebook, Youtube, SnapChat, Instagram, Weibo, LinkedIn and many others.

In traditional social media systems, users create profiles via a service providers website or app and all the content is maintained, processed and stored by the social media company. In such systems, users rely on the social media companies to store and protect their sensitive user data both while in flight, i.e. in transit and at rest, i.e. either at source or destination.

While users don't pay “directly” for use of these services, the services providers generate revenue from its user content and meta data through directed ads and selling access to their subscribers content for data mining or harvesting. This revenue then offsets the cost of maintaining the centralized servers and data centers and in some cases returns dividends to their shareholders.

Unfortunately, there are a number of serious drawbacks to this architecture. Most notably is the broken business model that requires the service provider to monetize their customers, which in turn requires their customers to give some, if not all of their privacy.

Additionally, the service provides have recently gone into censorship or “de-platforming” of content based on their or their advertisers best interests and not necessary the interest of their users or user communities. In some cases the censorship is at the direction of a central government but in most cases it is carried out based on arbitrary decisions of the social media service provides.

Complicating the matter, should a competitor wish to enter the market to compete against the entrenched social media companies it takes tremendous capital to build out the data centers and facilities to onboard even a single user. As users join the new network, more resources must be added to the central networks to manage the traffic load and to store the content being created by their users. At the end of the day, the new social media company would once again have to monetize their customer base, solicit advertisers and adhere to government oversight. While the new company might impose a different set of censorship policies than the legacy companies its still censorship by a third party and not by end users.

Further, social media companies typically deploy simply one-way authentication and HTTPS to secure their user's data in flight. Many enterprise networks (as well as others) are able to put a “man in the middle” of such traffic using an HTTPS proxy, thus exposing all data in flight to the intermediary and allowing that intermediary to filter, read, copy and save user content without them being aware of it.

One-way authentication only authenticates or assures the user that when they connect to a sight that “claims to be” say instagram, that in fact it is instagram. The converse is not true. The cryptographic system does not authenticate the client software used by the user and therefore must trust higher level protocols to assure that a user that claims to be user A is in fact user A, for example through passwords or other means.

Both sets of “keys”, the ones that attest to the service provider's identity and the passwords used by the “user” are not changed very often, and can actually not change for years. This means that if either key is broken, that all the user's or even sights' data can be exposed. Breaking the keys to access a sights meta data can expose all data of every user in the system. Breaking a given user's key can expose all of a user's stored content.

In summary, the current architecture of social media tends to lead to: (i) Third party censorship, sometimes legally, sometimes not; (ii) Lack of Privacy either on purpose or by accidental exposure; and (iii) Lack of free association.

The last point, lack of free association can best be understood by the fact that the social media companies can and do decide what user can and can not participate in their platform. Worse is that while excluding one user A from freely joining a given community and conversing with members of that community, the same platform may allow other members to make almost any claim about user A without allowing user A the ability to refute those claims. This leads to very bad social norms in which gangs of denizens roam from social media site to social media site spreading false or unsubstantiated claims about user A without user A being able to defend herself on any of those platforms.

Furthermore, because the user's content is held by a third party and the social media companies routinely change their terms of services, most users are unaware that their content may be retained or archived, indefinite. A frivolous statement which is deemed “social acceptable today” may be judged years into the future by a new set of standards and lead to harsh consequences including ability to get into schools and colleges, ability to get a job, ability to run for public office, etc. We call this effect “Future Guilt.”

Still further problems exist in the semantics of existing social interactions on social media sites. When someone creates content, they don't “own” that content, the social media company does. Even with as simple as email, “ownership” of content is fluid and the semantics of “polite” conversation are not a part of the system.

For example, if user A creates an email message and sends it to user B and in that email, user A included content that she did not want to disclose to anyone else, there is nothing in the art that would prevent user B from saving that information away, copying it or forwarding it to someone else like user C. Neither is user B prevented from replying to user A and copying additional users D, E, etc. on that reply. This sort of “lack of control” of content is pervasive in today's social media systems and this leads to a lack of polite discourse amongst members of society.

Content Distribution Networks (CDN's) are known in the art (https://en.wikipedia.org/wiki/Content_delivery_network). CDNs are a layer in the internet ecosystem. Content owners such as media companies and e-commerce vendors pay CDN operators to deliver their content to their end users. In turn, a CDN pays ISPs, carriers, and network operators for hosting its servers in their data centers.

CDN is an umbrella term spanning different types of content delivery services: video streaming, software downloads, web and mobile content acceleration, licensed/managed CDN, transparent caching, and services to measure CDN performance, load balancing, multi-CDN switching and analytics and cloud intelligence.

In all cases, CDN's share the “same” core content to all users that consume it. Adds and other localized information may be injected or added to the information, but the core information that is delivered to each user is the same.

Additionally, CDN's allow any user to consume the information they are caching. In other words, content, once shared to a CDN is then replicated and delivered to any subscriber (client) that wishes to read the content.

There are also peer-to-peer CDNs. In peer-to-peer (P2P) content- delivery networks, clients provide resources as well as use them. This means that unlike client-server systems, the content centric networks can actually perform better as more users begin to access the content (especially with protocols such as Bittorrent that require users to share). This property is one of the major advantages of using P2P networks because it makes the setup and running costs very small for the original content distributor.

### SUMMARY OF THE INVENTION

The present invention is systems and methods of delegation or replication on a private network, comprising: establishing a secure and encrypted private network with one or more profile computing devices; establishing a trust relationship on a whitelist for a first profile computing device; identifying categories of services provided to the first profile including one or more of the following: receiving and executing commands from the first profile; vetting a subscriber before inclusion in a service; receiving from a subscriber; distributing content to one or more subscribers in a group; revoking a subscriber from a group; or reporting task status; receiving a selection of one or more of the services from the first profile; executing one or more of the selected services on behalf of the first profile.

The systems and methods of delegation or replication on a private network, wherein the selection of one or more of the services includes: a conversation command to replicate to subscribers.

The systems and methods of delegation or replication on a private network, wherein the vetting of a subscriber further comprises one or more of the following: checking a blacklist on behalf of the first profile; checking reputation of the subscriber; or checking subscriptions of the subscriber.

The systems and methods of delegation or replication on a private network, further comprising: automatically accepting or rejecting a subscriber on behalf of the first profile based on a threshold; or indicating acceptance or rejection criterion to the first profile for decision making.

The systems and methods of delegation or replication on a private network, wherein reporting task status further comprises: customizing reports based on notification level setting from the first profile.

The systems and methods of delegation or replication on a private network, wherein revoking a subscriber further comprises: monitoring subscriber behavior; automatically revoking a subscriber based on threshold parameters indicating violation of rules of the private network; or recommending revocation of a subscriber to the first profile for decision-making.

The systems and methods of delegation or replication on a private network, receiving from a subscriber further comprises: creating subordinate conversation object associated with a conversation object only if subscriber is not on the blacklist of the first profile.

The systems and methods of delegation or replication on a private network, further comprising, executing a delete command from the first profile by deleting a conversation object and any associated subordinate conversation objects the secure objects on all profile computing devices on the private network other than the first profile computing device.

The systems and methods of delegation or replication on a private network, further comprising: preventing deletion of content by non-source profiles in the private network.

The systems and methods of delegation or replication on a private network, further comprising: executing a delete itself command including deleting all conversation objects and associated objects.

### BRIEF DESCRIPTION OF THE DRAWINGS

The embodiments of this invention are illustrated by way of example and not limitation in the figures of the accompanying drawings, in which like references indicate similar elements and in which:

FIG. 1 shows a diagram illustrating an example of systems and methods systems and methods of systems and methods of delegation or replication on a private network with different types and categories of computing devices including internet of things devices.

FIG. 2 shows exploded view of a computing device interacting with a private network, according to one embodiment.

FIG. 3 is staged view of actions, according to one embodiment.

FIG. 4 is a staged view of actions, according to one embodiment.

FIG. 5 is an exploded view of publisher computing device, according to one embodiment.

FIG. 6 shows a flowchart illustrating an example of a method of delegation or replication on a private network on a private network.

FIG. 7 is a schematic diagram of exemplary computing devices that can be used to implement the methods and systems disclosed herein, according to one embodiment.

### DETAILED DESCRIPTION OF THE INVENTION

The systems and methods of delegation or replication on a private network includes techniques to incorporate trusted subscribers that are vetted and trusted service providers that can accept delegation requests within a secure private network. This allows for the private network to dynamically leverage resources while retaining control and flexibility in its use. While a service provider may be a third-party, it is not a central service in the traditional sense. The service provider has to comply with the rules and restrictions of the private network.

The systems and methods of delegation or replication on a private network provides for a completely distributed social media platform that allows both humans and machines to freely associate with one another through a special salutation protocol. In this platform, there are no central service. There is no cost to stand up the platform. There are no additional costs as each new user joins the social network. Instead of a central service storing a user content and facilitating user content distribution and user discovery, all these facilities are provided in a peer to peer social network owned and operated by the users themselves.

No central authority can prevent the users from freely associating with one another nor can a third party exclude a given user from participation in social media with this system.

This invention discloses a novel mechanism that is used to aid in scaling any given user's social network size (the number of peers that a given user can distribute information to). First, we define a new trusted party: the replicator. The replicator can either be a service provided by a service provider (third party) or it can be dedicated hardware operated and owned by the publisher. Regardless of who operates the replicator, its operations are the same and it is only the ownership that varies.

The following describes each of the functional blocks that make up the replicator service. First, creating a Replicator Instance involves the following. These are the steps necessary to create a replicator instance. Note that the replicator itself can be multi-tenant/have more than one instance. Also note that it is anticipated that the replicator can be scaled using standard web scale technologies known in the art, such as using a location aware load balancer to distributed its work load among a number of devices located in various places and sharing a distributed data store.

Upon request from a publisher a new instance is created for the replicator. The replicator notes the endpointID of the publisher. For each new instance, the replicator creates a new “Alias” and associated public/private key pair which it then stores within its keyStore for later usage. From this point forward, the alias is used to identify the instance of the replicate having be created.

The replicator then forms a Signet which contains the alias, public key and network address of the replicator. Note that the network address may be the address of a load balancer or similar load distributing technology and not the actual device on which the replicator is running. The Signet is then sent to the publisher using any of the means described in the salutation protocol, disclosed in another patent. Publisher then completes salutation with the replicator using the Signet and enclosing its endpoint object (again using the salutation protocol).

The replicator associates the alias contained within the salutationPacket to associated the publisher with the instance created for the publisher. It then extracts the payload and adds the publisher's endpoint object to the known endpoints of the instance. The replicator identifies the “publisher” endpoint ID of the object as the publisher that created the instance. Finally, the publisher stores the Signet of the replicator for later use.

Second, creating a Conversation involves the following. Conversations are used by the publisher to create groups of messages or channels if you will that subscribers may be added to. Only the publisher, having created a replicator instance may create conversations. The publisher creates a conversation object, C1 where the publisher is the owner and no subscribers or messages yet exist.

The publisher then sends an addConversation message to the replicator which contains the conversation object C1. The replicator associates the alias of the message it receives with the instance of the replicator associated with the publisher and extracts the conversation object C1. The replicator then adds a master conversation object C1 to its collection of conversations. Note that replicators deal in master and subordinate conversation objects which we will detail more later.

Third, adding Subscribers involves the following. Subscribers are added to conversations by the publisher or some other process owned and operated by the publisher. Any means could be used to select/qualify subscribers including pre-determined lists, subscription services, etc.

Publisher sends the Signet of the Replicator instance that was earlier created to each new subscriber. The subscriber, using the standard salutation protocol, uses the Signet to send a requestRelationship packet to the replicator instance. Within that packet, the subscriber includes its endpoint object.

Replicator checks the black list and if the subscriber is not on the black list, it then sends a approvalRequest message containing the subscriber's endpoint object to the publisher associated with the replicator instance. The publisher having received the approvalRequest validates whether or not the subscriber can join the publication using any number of means including checking reputations, paid subscriptions, etc. Should the publisher reject the subscriber, the publisher may send a reject message to the replicator and the replicator may add the subscriber to the blacklist. Should the publisher accept the subscriber, then the publisher sends an approval message containing the subscribers endpoint object back to the replicator. Additionally, the publisher saves the endpoint object in its collection of endpoints. Upon approval, the replicator instance adds the endpoint object to the collection of endpoint objects associated with the instance.

The replicator then completes the salutation process with the subscriber by sending an acceptRelationship object back to the subscriber containing the replicator's endpoint object and alias associated with the replicator instance. The subscriber then adds the replicator's endpoint object to its collection of endpoints.

Fourth, adding a Subscriber to a Conversation involves the following. Subscribers can be added to one or more conversations, having been created by the publisher, who's master conversation objects reside on the instance of the replicator associated with the publisher.

To add a one or more subscribers to a conversation, C1, the publisher sends a addSubscribers object to the replicator. This object contains the conversation ID, C1 along with a list of zero or more endpointID's to be added to the conversation. The publisher also added each of the endpointID's to its local copy of the conversation object C1. The instance of the replicator associated with the publisher then selects the conversation object C1 from its collection of master conversation objects.

For each EndpointID listed within the addSubscribers message: The replicator adds the endpointID to the master conversation's list of participants. The replicator create a subordinate conversation object C1.EndpointID and adds the replicatorID and the EndpointID as participants to the conversation. The replicator sends a putConversation containing the subordinate conversation C1.EndpointID to the subscriber. The subscriber subsequently adds the conversation C1.EndpointID to its list of conversations.

Fifth, deleting a Subscriber involves the following. The publisher may delete or remove subscribers from any conversation for any reason including lapse of subscription, violation of terms of service, etc. First the publisher removes the endpointID's associated with a conversation C1 from the list of endpointID's participating in the conversation. The publisher sends a deleteSubscribers object to the publisher containing the conversation ID C1 along with a list of zero or more endpointID's to be removed from the conversation.

For each endpointID in the list, the replicator does the following. The replicator removes the endpoint ID from the master conversation C1. The replicator then looks up the subordinate conversation C1.EndpointID associated with the subscriber and deletes the conversation. The replicator then sends a deleteConversation message referencing C1.EndpointID to the subscriber. The subscriber then deletes the conversation C1.EndpointID along with all associated message objects.

Sixth, publishing a Message involves the following. The publisher may publish messages associated with any of his conversations he has created. Published messages are then forwarded to the replicator, where they are replicated and distributed to the subscribers of the conversation.

Publisher creates a message object M1 and associates it with conversation C1 by adding it to the list of messages contained within object C1. Publisher then sends a addMessage object to the replicator. The addMessage object contains a reference to conversation C1 and the message object M1. The replicator adds message M1 to the collection of messages associated with the replicator instance associated with the publisher. The replicator adds the message reference to master conversation object C1.

For each subscriber to conversation C1, the following occurs. The replicator adds the message reference M1 to the subordinate conversation C1.EndpointID. The replicator sends a addMessage object to the subscriber. The addMessage object contains a reference to conversation C1.EndpointID and the message object M1.

The subscriber checks the owner of the message (in this case the publisher) to see if it is in his black list. Since the publisher is never black listed, the following steps happen. The subscriber adds the message M1 to its collection of messages. The subscriber adds the reference to message M1 to his conversation object C1.EndpointID.

Seventh, replying to a Message involves the following. Subscribers may reply to messages within the context of a conversation that they are participants in. Note we don't block or suppress an individuals rights to participate in discourse. Subscribers may free dissociate with a publisher and they may black list messages from any other subscriber. Publishers may cancel a subscriber's subscription but must accept messages from subscribers in good standing.

Subscriber creates a new message object M1 within the context of a conversation object C1EndpointID. Subscriber adds a reference to message M1 to the conversation object C1EndpointID. Subscriber sends a addMessage object to the replicator (the only other participant in the conversation C1.EndpointID). The addMessage object contains a reference to C1.EndpointID and the message object M1.

The replicator then associated the subordinate conversation C1.EndpointID with the master conversation object C1. The replicator adds the message object M1 to its collection of messages associated with the publisher's instance. The replicator adds a message reference to master conversation object C1.

For each subscriber associated with conversation C1, the following occurs. The replicator looks up the associated subordinate conversation C1.EndpointID. The replicator adds the message reference to the subordinate conversation C1EndpointID. The replicator sends a addMessage object to the associated endpoint object. The add message contains a reference to conversation C1.EndpointID and the message object M1. The subscriber, validates that the owner of object M1 is not in his black list.

If the owner is not in his black list, then the subscriber adds message M1 to his collection of messages and a reference to M1 to the collection of messages associated with his conversation C1EndpointID. If the owner was blacklisted, then the subscriber ignores the message.

Eighth, deleting a Reply involves the following. Subscribers always own their reply messages and may freely update or delete them at their discretion. When they are updated, the are simply re-sent with a revised “lastChanged”. When they are deleted, the following steps take place.

The subscriber deletes message M1 associated with conversation C1.EndpointID. The subscriber removes the reference M1 from the list of message references contained in C1.EndpointID. The subscriber sends a deleteMessage object to the replicator. The deleteMessage object contains a reference to conversation C1.EndpointID and a reference to the message M1.

When the replicator receives the deleteMessage object, it extracts the subordinate and master conversation objects C1.EndpointID and C1. The replicator then deletes the message M1 from its collection of messages. The replicator then deletes the references to M1 from C1.EndpointID and C1.

For each endpoint ID (which includes the publisher) of C1, the replicator then: The replicator sends a deleteMessage object containing a reference to C1.EndpointID and a reference to message M1. When the subscriber/publisher receives the deleteMessage object the reference is removed from the associated conversation and the message is deleted from the collection of messages by the receiver.

Ninth, deleting a conversation, involves the following. Conversations can be deleted by their owner and in this case, the owner of all the conversations is the publisher. When the publisher deletes a conversation, then all messages associated with the conversation are removed from the publisher's device, the replicator and every subscribers device as well as the master conversation C1 and all subordinate conversation objects C1.EndpointID. The means are identical to what has already been listed.

Tenth, deleting a Replicator Instance involves the following. Replicator instances may be deleted by the publisher or by the replicator's operator (a third party.). When a replicator instance is deleted, then all objects associated with that instance including any endpoint objects, conversation objects and messages belonging the publisher or any of the subscribers are all deleted using the practices and methods already outlined above.

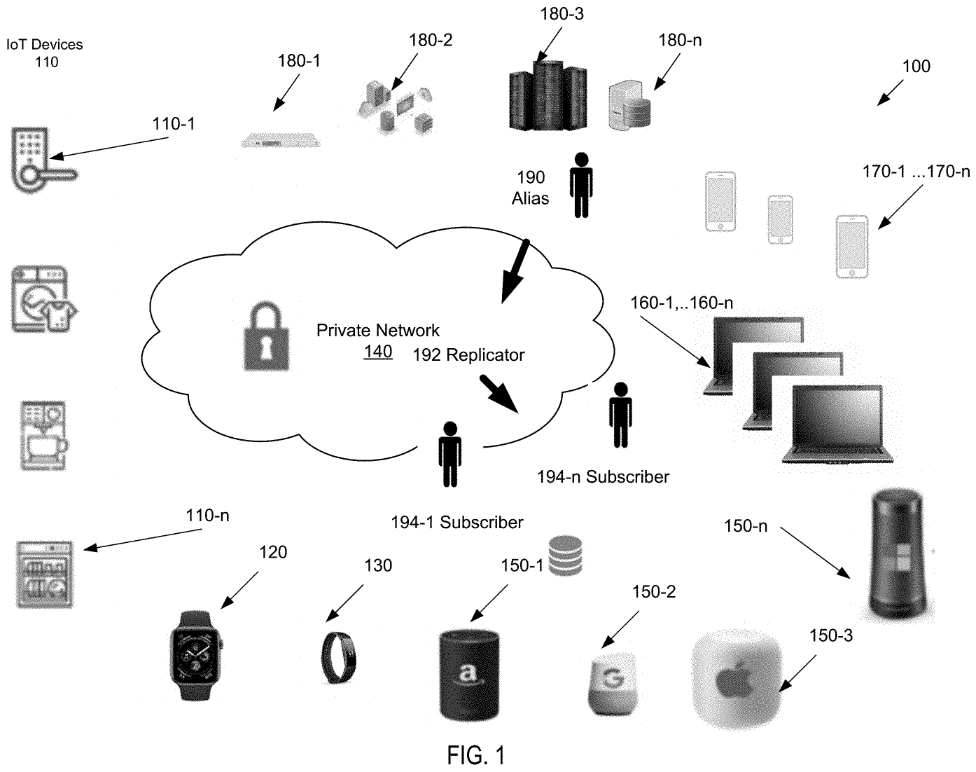

In one embodiment, FIG. 1 depicts a diagram 100 illustrating an example of securely connecting computing devices through the private network 140 as well as storing information securely on the computing devices before or after each transmission. In the example of FIG. 1, the environment includes a first IoT devices 110-1 through an nth client system 110-n, private network 140, a smart watch 120, a fitness tracker 130, intelligent voice assistants 150-1 to 150-n, personal computers from 160-1, . . . 160-n, smartphones from 170-1 to 170-n, servers from 180-1, . . . 180-n.

In an implementation, the IoT device 110 includes components related to network connectivity. In one implementation, the IoT device 110 includes speaker and/or microphone hardware and software components to enable receipt and execution of speech commands directly on the device. In another implementation, the IoT device 110 does not include a speaker and/or microphone capability to enable receipt and execution of speech commands directly on the device, yet the IoT device is able to communicate with the private network system to enable receipt and execution of speech commands translated to device specific SDK/API commands.

The data, information or content 190 is an alias on one of the computing devices on the private network that uses services delegation that flows through 192 Replicator to send to a subscriber list 194-1 to 194-n subscribers.

The role of the computing device manufacturers is separated from the use of the computing devices in hosting applications. After purchase, a user of the computing device has control on how to use, configure and communicate using that device. Use of any central services including those from the device manufacturer become optional. In one embodiment, there are one or more aliases associated with each of the computing devices including the IoT devices. The IoT devices integrate with the private network with zero additional programming. Different categories of smart watches 120, fitness trackers 130, personal computers 160 are connected securely and with encryption. The Intelligent voice assistants 150 can be from a variety of providers like Amazon Alexa, Google Home Assistant, Apple HomePod, Microsoft Cortana etc. Smartphones 170 and servers 180 with more computing power, bandwidth and capabilities are also connected. For example, the smallest computing device, i.e. an IoT doorbell ring to the largest computing device, a full-fledged server, are both treated equal in the digital private network world.

A person of ordinary skill in the art would appreciate that by integrating trusted service providers who are replicators and controlling the subscriber list to trusted subscribers, an alias with signet on the first computing device has control and flexibility on its publications. These publications could be triggered by a human or could be automated reporting or notification alerts by a machine.

Private Network 140 can be different wireless and wired networks available to connect different computer devices including client and server systems. In an implementation, private network 140 is publicly accessible on the internet through secure messaging protocol described herein. In an implementation, private network 140 is inside a secure corporate wide area network. In an implementation, private network 140 allows connectivity of different systems and devices using a computer-readable medium.

The messaging and notification between different components can be implemented using application programming interface (API) calls, extensible markup language (“XML”) or Javascript Object Notation (“JSON”) config file interfaces between different interfaces, Hypertext Preprocessor (earlier called, Personal Home Page) (“PHP”), Python, Node.js, Java/C++ object-oriented programming or simple web-based tools.

Different components may also implement authentication and encryption to keep the data and the requests secure. Authentication of a device may be accomplished using public/private key, passwords, token, transaction, biometrics, multi-factor authentication or other methods known in the industry. Encryption may use data encryption standard (DES), TripleDES, RSA, Advanced Encryption Standard (AES) or other methods known in the industry.

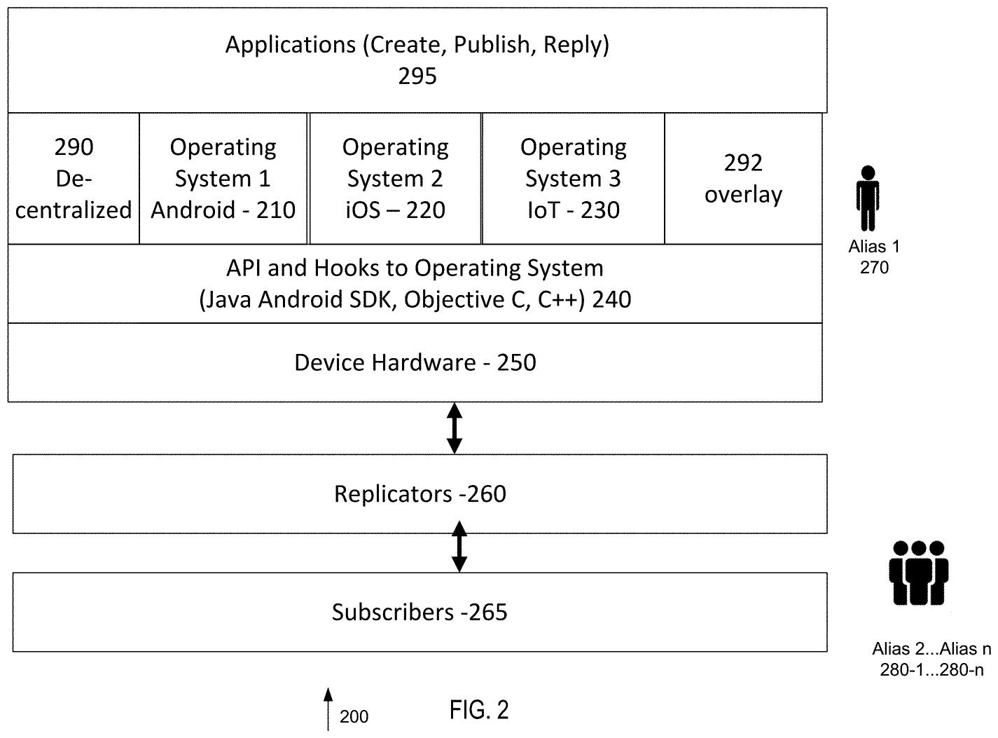

FIG. 2 is an exploded view 200 of different versions of an implementation that allow application programming interface, hooks, or overlay network connections in a computing device that hosts different applications. For example, Alias-1 270 is associated with a computing device that may have one or more operating systems including Android 210, iOS 220 or IoT operating system 230. The computing device includes device hardware 250 that can be controlled by the private network API/hooks 240 that are incorporated at a system level on the computing device. In one embodiment, depending on the computing device platform the private network overlay hooks are implemented using Java Android SDK, Objective C, or C++. In one embodiment, any and all communications are controlled using the private network overlay architecture that encompasses the operating system at 290 de-centralization module and 292 overlay network module. In one embodiment, a user can customize the alias to go in and out of the private network overlay architecture mode. The private network includes replicators 260 and subscribers 265 that replicate the applications or services 295 and send out to the subscribers who are a subset of the trusted alias 2 to alias n i.e. 280-1 to 280-n all of which can communicate with Alias-1 using authenticated, secure and encrypted channels. In one embodiment, the overlay network is based on peer to peer network. In one embodiment, the private network using an overlay network using the existing public network.

In one embodiment, the computing device includes applications or services that can create content, publish content and reply to messages 295 in the private network. The list of replicators 260 depend on established trusted relationships. Adding on the subscriber list 265 also depends on established trusted relationships.

Services that can be replicated include, for example, email, fax, storage, financial book-keeping, storage services, HR services, publishing, document processing, tax services, etc. The subscribers use one or more of the services that are provided by the alias 1.

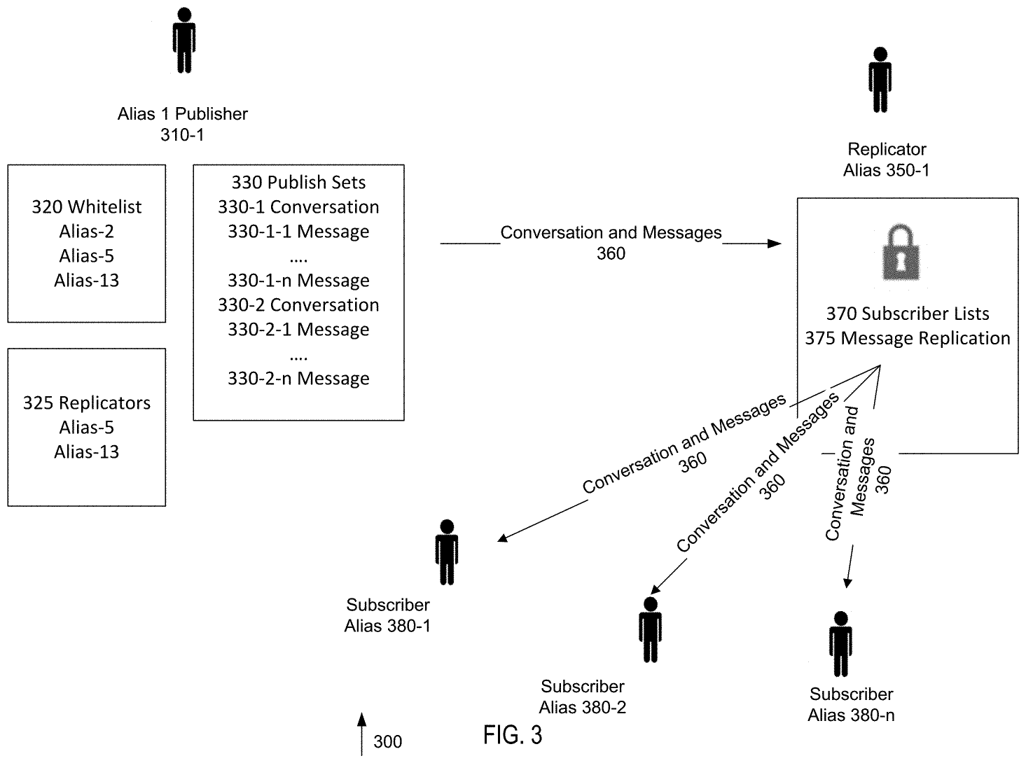

FIG. 3 outlines 300 showing actions related to replicator and subscriber services between an alias 1 at 310-1 who is a publisher and its replicator at Alias 350-1 that is sent out to Subscribers at alias 380-1 to 380-n. One more replicators may offer the same services for Alias 310-1. In this example, replicator 350-1 initially establishes a trust relationship with Alias 310-1 to provide services. Replicator has to get on the whitelist 320. In one embodiment, may charge for the services provided. Payment could be using traditional or digital currency including for example cryptocurrency. Services could be one or more services provided in the digital domain. For example, in one embodiment, the underlying platform is a peer to peer network using the blockchain platform.

At the outset, Alias-1 includes a whitelist, a replicator list and content that is 330 publish sets including one or more conversations 330-1 to 330-n, that includes messages 330-1-1 to 330-n-n. Each time messages or conversations are added, edited or deleted, an update is sent to conversations and messages message 360 to the replicators and subsequently forwarded to the subscribers. Alias-1 just has to send a single message that is then replicated across multiple subscribers at the replicator. All the messages stay secure and encrypted and all entities/devices involved continue to comply with the rules and restrictions of the private network.

Each message at the replicator is replicated individually for each subscriber using the subscriber's public key. This method ensures that the receipt is authenticated and only the intended subscriber can decode the message. Depending on the number of subscribers, the cryptography can get intensive. A person of ordinary skill in the art would understand that known techniques of parallel processing and using multiple processors to accomplish intense cryptographic computations can be used with additional resources for both hardware and software. Replicators can be high-end servers who can handle this load and have the bandwidth. Alias-1 can freely, flexibly and with control use the replicator services without having to upgrade any of its own computing device power.

The replicator maintains a 370 subscriber lists. In one embodiment, the addition, revision and deletion of the subscriber list is handled at the replicator. In one embodiment, the addition, revision and deletion of the subscriber list is handled at the alias-1 publisher and sent in an encrypted message for use at replicator. In one embodiment, both alias-1 publisher and replicator can perform addition, revision or deletion of the subscriber list and notify the other whenever there is an update.

The replicator also maintains message replication 375 indexing and replication process. There is an association between the subscribers' identification and corresponding conversations or messages. The replicator would include a status table on which subscribers have received the updates and are behaving. In one embodiment, the replicator monitors the subscriber behavior and give periodic feedback to the publisher. In one embodiment, the replicator can recommend revocation of a subscriber who is not behaving according to the rules and restrictions of the private network. A replicator may also investigate and vet a subscriber based on publicly available information before adding him to the subscriber list for a service.

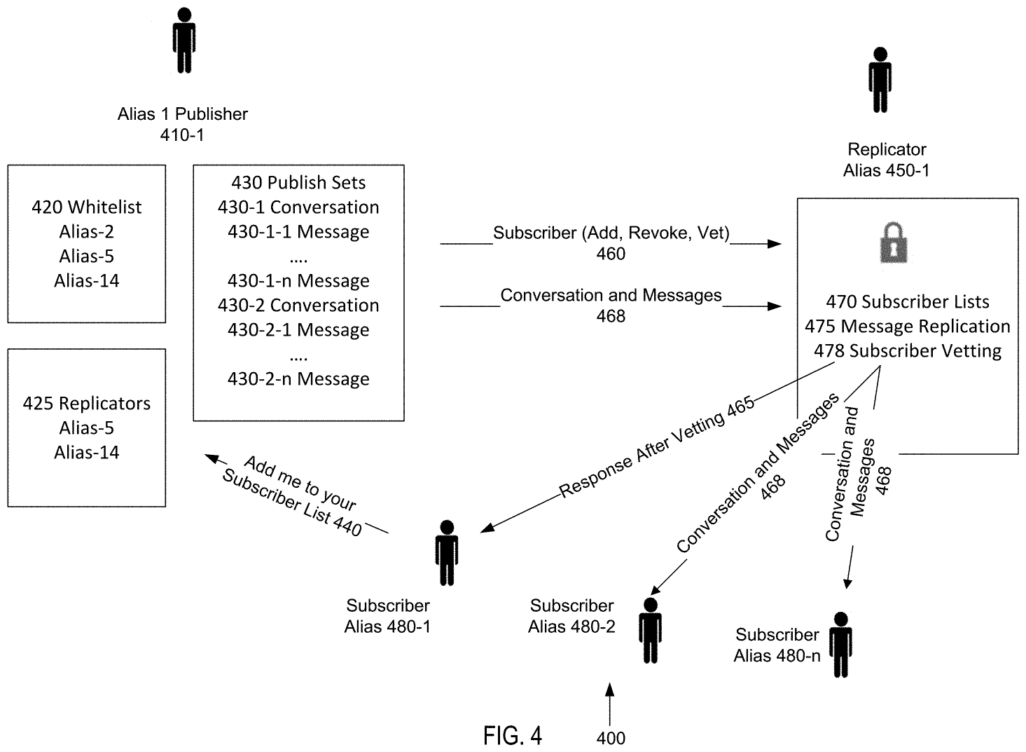

FIG. 4 with 400 shows actions between a publisher, a replicator and subscribers for the private network. Similar to what is shown in FIG. 3, Publisher 410-1 has an established whitelist 420, 425 Replicators list and 430 Publish sets with conversations 430-1 to 430-n and Messages 430-1-1 to 430-n-n. Message 440 is from Alias 480-1,s a new subscriber who wants to enroll in one of the services published by the publisher. Publisher notifies its replicator 450-1 using message 460 that a new subscriber is requesting addition to its subscriber list. In one embodiment, Replicator 450-1 then gives feedback that goes towards 478 vetting subscriber's past behavior, current status and fitness to join the subscriber list. In one embodiment, the decision to add the subscriber is automated at the replicator using artificial intelligence modules that are customized by the publisher. In one embodiment, the decision to add the subscriber is made by the publisher. In one embodiment, the decision to add the subscriber is automatically made at the publisher. In one embodiment, user input is sought to make the final decision as to whether to add or reject the subscriber.

The decision is conveyed to the subscriber by the replicator using message 465. If the subscriber is added to the list, it starts receiving conversation and message updates 468 that also go to other subscribers 480-2 to 480-n. The replicator has the 470 subscriber lists module that is kept current. 475 is the message replication process and 478 is the subscriber vetting module. In one embodiment, the subscriber vetting includes input based on customized user settings. In one embodiment, the subscriber vetting includes artificial intelligence modules that learns different user settings.

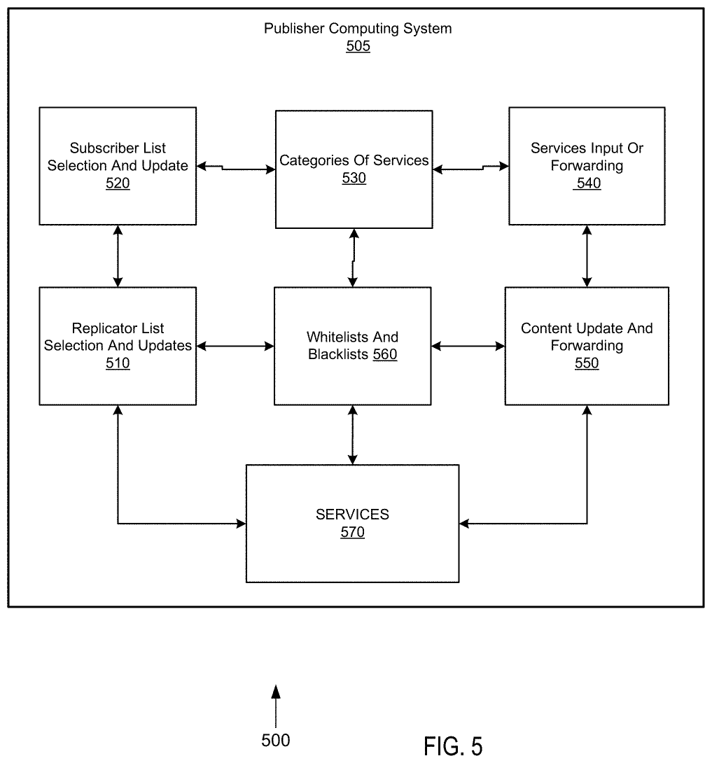

FIG. 5 with 500 shows an exploded view of publisher computing device 505 and the modules incorporated. At 570, the module is triggered for different services. The services module maintains a list of services that are provided by the 505 device. It allows customization, addition, revision and deletion of new services on the system. In one embodiment, the service may be publicly available and is then also provided in a restricted manner for the private network. At 510, replicator list, selection and updates are dynamically performed by the module. The system monitors whether a replicator has been performing its functions with good quality. At 520, module is used to maintain subscriber list, selection and update. In one embodiment, the module may be delegated to the replicator and the publisher gets notifications of the subscribers list. In one embodiment, the publisher does its own vetting of subscribers. At 530, different categories of services and corresponding replicators are associated. For example, depending on the type of service, the requirements for the replicator changes with regards to network, bandwidth and computing power. At 540, services input or forwarding is handled. This module keeps a list of active and well-performing replicators associated with different services. Services input includes requests to add new services, revise services or delete services. At 550, the module includes content update and forwarding. Any new creation of content includes content that needs to be published and associated messages.

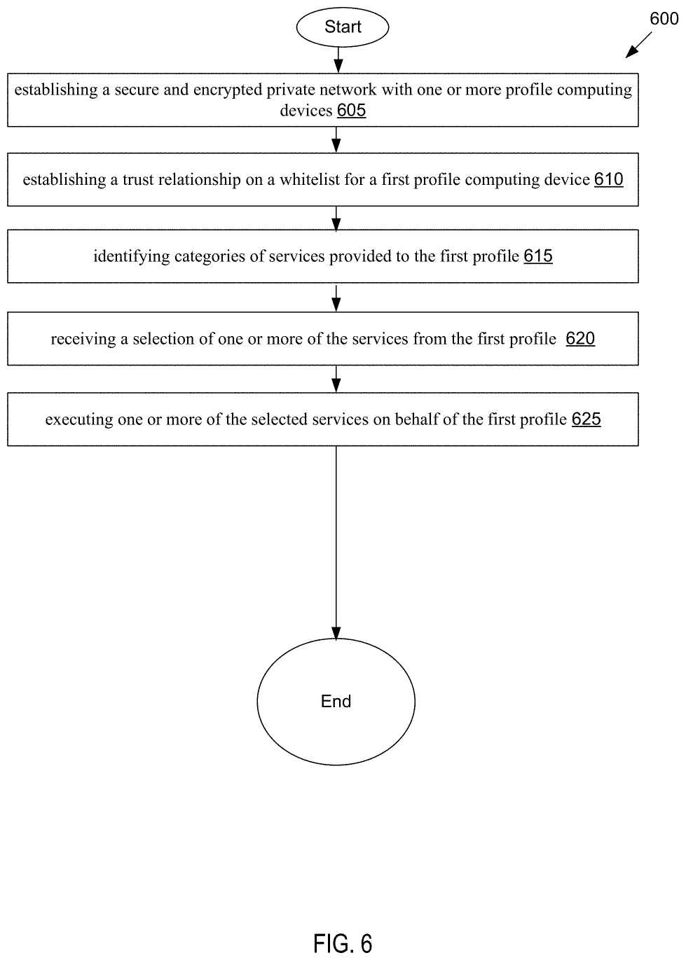

FIG. 6 depicts a flowchart 600 illustrating an example of a method of replicator and subscriber on a private network. The flowchart 600 is discussed in conjunction with the environment shown in the diagram 100 in FIG. 1. At block 605, begins with establishing a secure and encrypted private network with one or more profile computing devices. At block 610, establishing a trust relationship on a whitelist for a first profile computing device. At block 615, identifying categories of services provided to the first profile. In one embodiment, the categories include: receiving and executing commands from the first profile; vetting a subscriber before inclusion in a service; receiving from a subscriber; distributing content to one or more subscribers in a group; revoking a subscriber from a group; or reporting task status. At block 620, receiving a selection of one or more of the services from the first profile. At block 625, executing one or more of the selected services on behalf of the first profile. A person of ordinary skill in the art would appreciate that by following the steps outlined above that is inbuilt into the computing device, the private network enforces delegation or replication services that are trusted, customized control at the data level that is implemented network-wide and distribution is to a trusted subscribers list that can be customized dynamically.

In a broad embodiment, the invention is systems and methods of delegation or replication on a private network allows scaling of data distribution on the private network to leverage network and computing powers at replicators for large scale subscribers while allowing the publisher to establish trust before delegation and vetting subscribers.

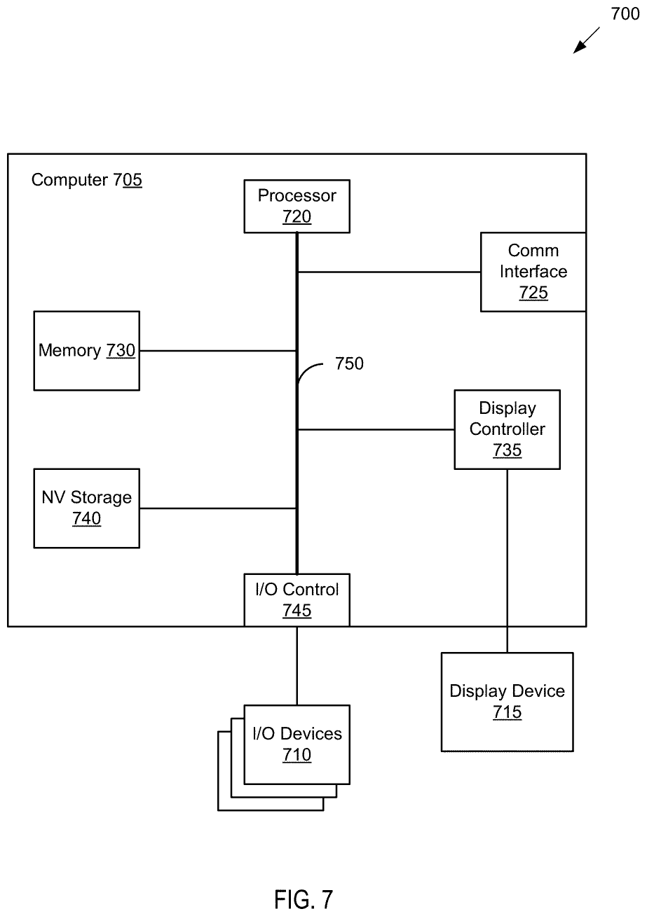

FIG. 7 is a schematic diagram of computing device 700 that can be used to implement the methods and systems disclosed herein, according to one or more embodiments. FIG. 7 is a schematic of a computing device 700 that can be used to perform and/or implement any of the embodiments disclosed herein. In one or more embodiments, IoT device 110, SDK/API 120, Speak-to-IoT system 130, voice assistants 150, user end devices with mobile apps 170 or 180 of FIG. 1 may be the computing device 700.

The computing device 700 may represent various forms of digital computers, such as laptops, desktops, workstations, personal digital assistants, servers, blade servers, mainframes, and/or other appropriate computers. The computing device 700 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

FIG. 7 shows an example of a computing device 700 on which techniques described here can be implemented. The computing device 700 can be a conventional computer system that can be used as a client computer system, such as a wireless client or a workstation, or a server computer system. The computing device 700 includes a computer 705, I/O devices 710, and a display device 715. The computer 705 includes a processor 720, a communications interface 725, memory 730, display controller 735, non-volatile storage 740, and I/O controller 745. The computer 705 may be coupled to or include the I/O devices 710 and display device 715.

The computer 705 interfaces to external systems through the communications interface 725, which may include a modem or network interface. It will be appreciated that the communications interface 725 can be considered to be part of the computing device 700 or a part of the computer 705. The communications interface 725 can be an analog modem, integrated services for digital networks (“ISDN”) modem, cable modem, token ring interface, satellite transmission interface (e.g. “direct personal computer” also known as “direct PC”), or other interfaces for coupling a computer system to other computer systems.

The processor 720 may be, for example, a conventional microprocessor such as an Intel Pentium microprocessor or Motorola power PC microprocessor. The memory 730 is coupled to the processor 720 by a bus 750. The memory 730 can be Dynamic Random Access Memory (DRAM) and can also include Static RAM (SRAM). The bus 750 couples the processor 720 to the memory 730, also to the non-volatile storage 740, to the display controller 735, and to the I/O controller 745.

The I/O devices 710 can include a keyboard, disk drives, printers, a scanner, and other input and output devices, including a mouse or other pointing device. The display controller 735 may control in the conventional manner a display on the display device 715, which can be, for example, a cathode ray tube (CRT) or liquid crystal display (LCD). The display controller 735 and the I/O controller 745 can be implemented with conventional well-known technology.

The non-volatile storage 740 is often a magnetic hard disk, an optical disk, or another form of storage for large amounts of data. Some of this data is often written, by a direct memory access process, into memory 730 during execution of software in the computer 705. One of skill in the art will immediately recognize that the terms “machine-readable medium” or “computer-readable medium” includes any type of storage device that is accessible by the processor 720 and also encompasses a carrier wave that encodes a data signal.

The computing device 700 is one example of many possible computer systems that have different architectures. For example, personal computers based on an Intel microprocessor often have multiple buses, one of which can be an I/O bus for the peripherals and one that directly connects the processor 720 and the memory 730 (often referred to as a memory bus). The buses are connected together through bridge components that perform any necessary translation due to differing bus protocols.

Network computers are another type of computer system that can be used in conjunction with the teachings described here. Network computers do not usually include a hard disk or other mass storage, and the executable programs are loaded from a network connection into the memory 730 for execution by the processor 720. A Web TV system, which is known in the art, is also considered to be a computer system, but it may lack some of the components shown in FIG. 7, such as certain input or output devices. A typical computer system will usually include at least a processor, memory, and a bus coupling the memory to the processor.

Though FIG. 7 shows an example of the computing device 700, it is noted that the term “computer system,” as used here, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 7.

The memory can include, by way of example but not limitation, random access memory (RAM), such as dynamic RAM (DRAM) and static RAM (SRAM). The memory can be local, remote, or distributed. As used here, the term “computer-readable storage medium” is intended to include only physical media, such as memory. As used here, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory here. Even when software is moved to the memory for execution, the processor will typically make use of hardware registers to store values associated with the software, and local cache that, ideally, serves to speed up execution. As used here, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

A person of ordinary skill in the art would appreciate that delegation and replication on the private network for trusted subscribers allows for network wide control and flexibility by providing a protocol to establish trust both at service provider level as well as subscriber level. It allows leveraging network-wide resources.

Several components described here, including clients, servers, and engines, can be compatible with or implemented using a cloud-based computing system. As used here, an overlay network including, for example, a peer to peer network, is a system that provides computing resources, software, and/or information to client systems by maintaining de-centralized services and resources that the client systems can access over a communications interface, such as a network. A person of ordinary skill in the art would understand that different modules or components described herein could be implemented using a cloud-based computing system. Such systems can involve a subscription for services or use a utility pricing model. Users can access the protocols of the private network through a web browser or other container application located on their client system.

The invention disclosure describes techniques that those of skill in the art can implement in numerous ways. For instance, those of skill in the art can implement the techniques described here using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used here, the term ‘processor’ refers to one or more devices, circuits, and/or processing cores configured to process data, such as computer program instructions.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described here relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMS), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order. The structures and modules in the figures may be shown as distinct and communicating with only a few specific structures and not others. The structures may be merged with each other, may perform overlapping functions, and may communicate with other structures not shown to be connected in the figures.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tapes, disks, integrated circuits, and servers. The instructions are operational when executed by the processor to direct the processor to operate in accord with some embodiments. Those skilled in the art are familiar with instructions, processor(s), and storage medium.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The structures and modules in the figures may be shown as distinct and communicating with only a few specific structures and not others. The structures may be merged with each other, may perform overlapping functions, and may communicate with other structures not shown to be connected in the figures.

1. A method of delegation or replication on a private network, comprising:
establishing a secure and encrypted private network with one or more profile computing devices;
establishing a trust relationship on a whitelist for a first profile computing device;
identifying categories of services provided to the first profile including one or more of the following:
receiving and executing commands from the first profile;
vetting a subscriber before inclusion in a service;
receiving from a subscriber;
distributing content to one or more subscribers in a group;
revoking a subscriber from a group; or
reporting task status;
receiving a selection of one or more of the services from the first profile;
executing one or more of the selected services on behalf of the first profile.

2. The method of claim 1, wherein the selection of one or more of the services includes:
a conversation command to replicate to subscribers.

3. The method of claim 1, wherein the vetting of a subscriber further comprises one or more of the following:
checking a blacklist on behalf of the first profile;
checking reputation of the subscriber; or
checking subscriptions of the subscriber.

4. The method of claim 3, further comprising:
automatically accepting or rejecting a subscriber on behalf of the first profile based on a threshold; or
indicating acceptance or rejection criterion to the first profile for decision making.

5. The method of claim 1, wherein reporting task status further comprises:
customizing reports based on notification level setting from the first profile.

6. The method of claim 1, wherein revoking a subscriber further comprises:
monitoring subscriber behavior;
automatically revoking a subscriber based on threshold parameters indicating violation of rules of the private network; or
recommending revocation of a subscriber to the first profile for decision-making.

7. The method of claim 1, receiving from a subscriber further comprises:
creating subordinate conversation object associated with a conversation object only if subscriber is not on the blacklist of the first profile.

8. The method of claim 1, further comprising, executing a delete command from the first profile by deleting a conversation object and any associated subordinate conversation objects the secure objects on all profile computing devices on the private network other than the first profile computing device.

9. The method of claim 1, further comprising:
preventing deletion of content by non-source profiles in the private network.

10. The method of claim 1, further comprising:
executing a delete itself command including deleting all conversation objects and associated objects.

11. A system of delegation or replication on a private network, comprising:
a secure and encrypted private network with one or more profile computing devices configured to:
establish a trust relationship on a whitelist for a first profile computing device;
identify categories of services provided to the first profile including one or more of the following:
receive and execute commands from the first profile;
vet a subscriber before inclusion in a service;
receive from a subscriber;
distribute content to one or more subscribers in a group;
revoke a subscriber from a group; or report task status;
receive a selection of one or more of the services from the first profile;
execute one or more of the selected services on behalf of the first profile.

12. The system of claim 11, wherein the selection of one or more of the services includes:
a conversation command to replicate to subscribers.

13. The system of claim 11, wherein the vet of a subscriber further comprises one or more of the following:
check a blacklist on behalf of the first profile;
check reputation of the subscriber; or
check subscriptions of the subscriber.

14. The system of claim 13, further comprising:
automatically accept or reject a subscriber on behalf of the first profile based on a threshold;
or
indicate acceptance or rejection criterion to the first profile for decision making.

15. The system of claim 11, wherein report task status further comprises:
customize reports based on notification level setting from the first profile.

16. The system of claim 11, wherein revoke a subscriber further comprises:
monitor subscriber behavior;
automatically revoke a subscriber based on threshold parameters indicating violation of rules of the private network; or
recommend revocation of a subscriber to the first profile for decision-making.

17. The system of claim 11, wherein receive from a subscriber further comprises:
create subordinate conversation object associated with a conversation object only if subscriber is not on the blacklist of the first profile.

18. The system of claim 11, further comprising, execute a delete command from the first profile by deleting a conversation object and any associated subordinate conversation objects the secure objects on all profile computing devices on the private network other than the first profile computing device.

19. The system of claim 11, further comprising:
prevent deletion of content by non-source profiles in the private network.

20. The system of claim 11, further comprising:
execute a delete itself command including deleting all conversation objects and associated objects.
